(19) United States
(12) Patent Application Publication
(10) Pub. No.: US 2002/0131089 A1
(43) Pub. Date: Sep. 19, 2002

(54) Internet facsimile machine, and internet facsimile communication method

(75) Inventor: Yoshifumi Tanimoto, Uji-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/096,996

(22) Filed: Mar. 12, 2002

(30) Foreign Application Priority Data
Mar. 14, 2001 (JP) 2001-071818
Jul. 3, 2001 (JP) 2001-201759
Jan. 23, 2002 (JP) 2002-014241

(51) Int. Cl. H04N 1/00

(52) U.S. Cl. 358/402

(57) ABSTRACT

When an Internet facsimile machine as a transmitter transmits electronic mail having attached image data, the Internet facsimile machine of the transmitter can easily designate processing of the image data. When an Internet facsimile machine as a receiver receives the electronic mail, the Internet facsimile machine of the receiver carries out the processing of the image data based on a command 15a and an operand 15b. The command 15a and the operand 15b are written in a mail account designated area of a mail address which is designated as a destination.

### CROSS REFERENCES TO RELATED APPLICATIONS

This application claims priority under 35 USC 119 of Japanese Patent Application Nos. 2001-071818, 2001-201759, and 2002-014241 filed in JPO on Mar. 14, 2001, Jul. 3, 2001, and Jan. 23, 2002, respectively, the entire disclosures of which are incorporated herein by reference.

### BACKGROUND OF THE INVENTION

1. Field of the Invention

The present invention relates to an Internet facsimile machine and an Internet facsimile communication method in which an Internet facsimile machine at the transmitting side can designate processing of image data to be processed by an Internet facsimile machine at the receiving side. Further, in this Internet facsimile machine and method, the Internet facsimile machine at the receiving side can easily determine a processing pattern of the received electronic mail, and carry out the necessary processing pattern.

2. Description of the Related Art

It is widely known that there is an Internet facsimile machine having a function for transmitting and receiving the image data by using the electronic mail and having a G3 facsimile function. Hereinbelow, the facsimile machine connected to the Internet (i.e., the Internet facsimile machine) will be referred to also as “I-FAX”. The G3 facsimile machine is a facsimile machine which carries out a facsimile communication procedure by the Group 3 (G3) facsimile transmission procedure standardized by the ITU-T (International Telecommunication Union) Recommendation T.30 for the facsimile communication.

Such an I-FAX is capable of carrying out various processing to the received image data. That is, from an operation unit of the I-FAX, an operator carries out setting in advance to the image data which is received by the I-FAX, and in this manner, the I-FAX can, for example, print the received image data, distribute the received image data to another facsimile machine by G3 facsimile, distribute the received image data to a client under the command, or carry out group distributing of the received image data to a plurality of registered terminals.

Moreover, accompanying the recent spreading of the Internet, the I-FAX is also capable of carrying out the facsimile communication with a communication terminal device such as another I-FAX connected to the Internet. In such a case, the facsimile communication is carried out by the communication procedure T.37 which is the facsimile communication protocol using SMTP (Simple Mail Transfer Protocol). The SMTP is one of the electronic mail protocols.

As in the manner stated above, when carrying out the facsimile communication by using the SMTP and connecting the I-FAX to another I-FAX via the Internet, the image data is transmitted as an attached file of the electronic mail. The I-FAX at the receiving side carries out the processing such as printing, in accordance with necessity, to the image data attached to the received electronic mail.

The I-FAX can be used in various forms. For example, there are cases in which the I-FAX is provided in both a head office and a branch office respectively, and the electronic mail to which the image data is attached is used for exchanging information related to the business. In such a case, at the I-FAX of the receiving side, when it is unclear which kind of processing is to be carried out to the received electronic mail having the attached image data, the I-FAX at the receiving side asks of the I-FAX at the transmitting side which processing should be carried out. Moreover, there are cases in which the I-FAX at the transmitting side instructs the I-FAX at the receiving side on the handling of the received electronic mail.

However, it is necessary to make a predetermined setting from the operation unit or the like of the I-FAX in advance in order to cause the I-FAX to carry out the processing of various image data. Therefore, the I-FAX at the transmitting side cannot designate what kind of processing of the image data attached to electronic mail should be carried out by the I-FAX at the receiving side.

Furthermore, when it is necessary that the I-FAX at the receiving side inquire of the I-FAX at the transmitting side on the received image data, the I-FAX at the receiving side has to carry out an additional increased process. In addition to that, when the I-FAX at the transmitting side designates processing of electronic mail which is to be carried out by the I-FAX at the receiving side, the I-FAX at the transmitting side has to write a message in the main text of the electronic mail, so that the process to be performed at the transmitting side becomes increased, in a certain case, troublesome.

### SUMMARY OF THE INVENTION

It is thus an object of the present invention to provide an Internet facsimile machine and an Internet facsimile communication method in which an Internet facsimile at the transmitting side is capable of easily designating processing of image data which is to be carried out by an Internet facsimile machine which will receive the image data, and the Internet facsimile machine which has received the image data can easily determine what kind of processing of the received image data should be performed, and perform the necessary processing.

According to one aspect of the present invention, there is provided an Internet facsimile machine including means for receiving electronic email, and means for carrying out processing of the received electronic mail and image data attached thereto on the basis of specific information which is written in a mail account designated area of a mail address designated as the destination. Accordingly, by using the mail account designated area, the I-FAX at the transmitting side can designate processing of the image data which will be carried out by the I-FAX at the receiving side. Therefore, an operator of the I-FAX at the transmitting side does not need to move to the I-FAX at the receiving side in order to designate processing of the image data received by the I-FAX at the receiving side.

According to another aspect of the present invention, there is provided an Internet facsimile machine in which the specific information is a command showing a processing instruction of the image data and is an operand. Therefore, by designating, for example, a location where outputting of the image data is carried out, it is possible to easily designate processing of the image data in more detail.

According to another aspect of the present invention, there is provided an Internet facsimile machine in which the processing indication includes one of: printing of the image data; facsimile forwarding of the image data; and local distributing of the image data. Therefore, there is an advantage similar to the above-mentioned I-FAX concerning printing of the image data, facsimile forwarding of the image data, or local distributing of the image data.

According to another aspect of the present invention, there is provided an Internet facsimile machine including means for storing processing attributes relating to the processing indication in which the I-FAX carries out the processing based on the processing attributes. Therefore, the I-FAX has the advantage similar to the above-mentioned I-FAX, and is capable of changing the designation of the processing of the image data randomly by changing the processing attributes. That is, the I-FAX can flexibly meet processing demanded by a user.

According to another aspect of the present invention, there is provided an Internet facsimile machine including an inputting unit for inputting various commands to be used in an electronic mail protocol, and inputting a keyword which designates a processing pattern of the electronic mail. Therefore, each time the facsimile communication is carried out, the necessary processing can be selected from the processing patterns of the electronic mail in accordance with a destination so as to designate the processing.

According to another aspect of the present invention, there is provided an Internet facsimile machine which divides the image data comprised of consecutive pages into page units, and the image data of each page is transmitted to the I-FAX at the receiving side by being attached to separate electronic mail respectively. Therefore, the risk when transmitting the image data in the form of the electronic mail can be divided.

According to another aspect of the present invention, there is provided an Internet facsimile machine in which the keyword includes a file name of the image data comprised of the consecutive pages, information showing the total number of pages of the image data of the file name, and information showing the page number of the image data attached to each electronic mail. Accordingly, when transmitting the original comprised of a plurality of pages in the form of the electronic mail, the electronic mail is formed by the page unit, and a plurality of electronic mails are transmitted within one SMTP session. Therefore, there is an advantage in that the I-FAX at the receiving side is capable of processing the received electronic mail by the page unit.

According to another aspect of the present invention, there is provided an Internet facsimile machine in which the keyword includes information of the processing order of the image data attached to each electronic mail. Therefore, at the receiving side, the processing of the received electronic mail having the attached image data can be carried out in order and appropriately.

According to another aspect of the present invention, there is provided an Internet facsimile communication method in which the keyword for indicating the processing pattern of the electronic mail to be performed by the receiving side is attached to the destination designation command of the electronic mail protocol, and the electronic mail having the keyword is then transmitted to the receiving side. Therefore, the I-FAX at the receiving side can easily determine the processing of the electronic mail in accordance with the indication made by the transmitting side, and perform the necessary processing immediately. Moreover, since it is not necessary to write the processing pattern of the electronic mail in the main text of the electronic mail, the processing by the transmitting side can also be carried out simply.

According to another aspect of the present invention, there is provided an Internet facsimile communication method in which when dividing the image data comprised of consecutive pages into page units, attaching the image data of each page to each electronic mail respectively, and then transmitting each electronic mail to the receiving side, the keyword includes the file name of the image data of the consecutive pages, the information showing the total number of pages of the image data of the file name, and the information showing the page number of the image data attached to each electronic mail. Therefore, there is an advantage in that the risk when transmitting the image data in the form of the electronic mail can be divided, and the received electronic mail can be processed by the page unit.

According to another aspect of the present invention, there is provided an Internet facsimile communication method in which when dividing the image data comprised of consecutive pages into page units, attaching the image data of each page to each electronic mail respectively, and transmitting each electronic mail to the receiving side, the keyword includes the information of the processing order of the image data attached to each electronic mail. Therefore, the risk when transmitting the image data in the form of the electronic mail can be divided, and at the receiving side, the processing of the received electronic mail having the attached image data can be carried out appropriately.

Additional objects, aspects, benefits and advantages of the present invention will become apparent to those skilled in the art to which the present invention pertains from the subsequent detailed description and the appended claims, taken in conjunction with the accompanying drawings

### BREIF DESCRIPTION OF THE DRAWINGS

FIG. 1 is a block diagram showing an example of the hardware structure of an I-FAX according to an embodiment of the present invention;

FIG. 2 is a data table which is referred to when processing the image data received by the I-FAX of FIG. 1;

FIG. 3 is a view illustrating transmission and reception of the SMTP command which is used by the I-FAX of FIG. 1;.

FIG. 4 is a block diagram showing an example of a network environment provided with the I-FAX of FIG. 1;

FIG. 5 is a flow chart showing an operation of the I-FAX of FIG. 1;

FIG. 6 is a view showing an example of the sequence of the SMTP according to the embodiment;

FIG. 7 is a flow chart showing an example of processing patterns of the electronic mail according to the embodiment;

FIG. 8 is an illustration showing an example of the processing according to the embodiment; and

FIG. 9 is an illustration showing an example of the processing according to the embodiment.

### DETAILED DESCRIPTION OF THE INVENTION

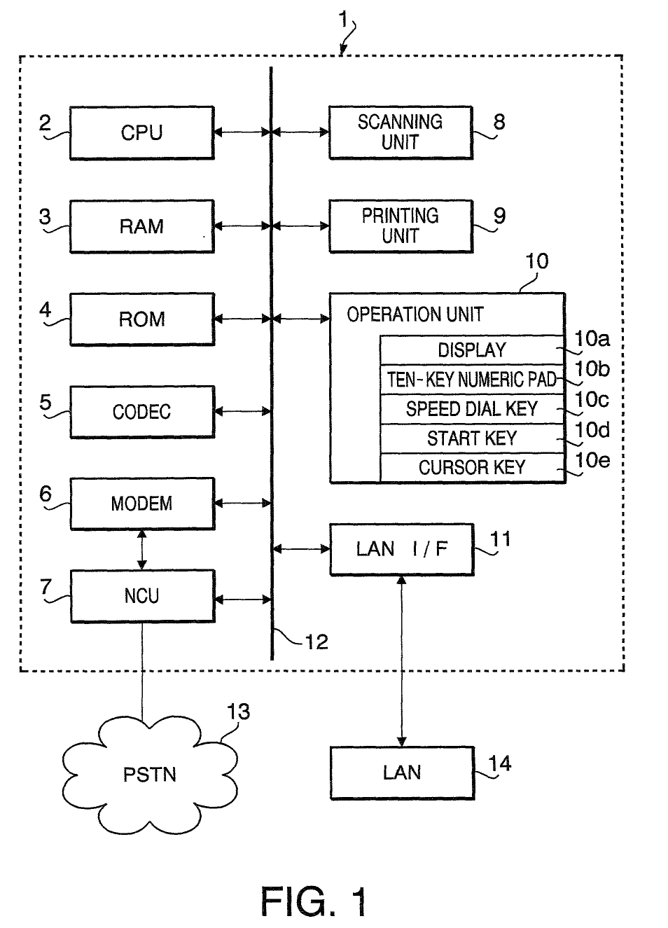

An I-FAX of an embodiment of the present invention will be described in accordance with the accompanying drawings. As shown in FIG. 1, the I-FAX 1 includes a CPU (Central Processing Unit) 2, a RAM (Random Access Memory) 3, a ROM (Read Only Memory) 4, a codec 5, a modem 6, an NCU (Network Control Unit) 7, a scanning unit 8, a printing unit 9, an operation unit 10, and a LAN I/F 11. These units 2 to 11 are connected to each other via a bus 12 such that communication can be carried out among these units.

The CPU 2 controls each unit which is an element of the I-FAX 1 in accordance with a predetermined program. The CPU 2 functions as a control unit for determining processing based on an instruction of a keyword as will be described later on.

The RAM 3 functions as a storing unit for storing image data, FAX numbers, mail addresses, data tables to be mentioned later on, and various commands to be used in an electronic mail protocol, and also functions as a storing unit for various data to be accumulated temporarily.

The ROM 4 stores various programs for controlling the operation of each unit of the I-FAX 1 by the CPU 2.

The codec 5 carries out encryption and decryption in accordance with a plurality of protocols. In other words, the codec 5 encrypts image data by MH (Modified Huffman), MR (Modified Read), MMR (Modified Modified Read) methods or the like in order to transmit the image data scanned by the scanning unit 8, and decrypts received image data. Furthermore, the codec 5 is also capable of encrypting and decrypting image data in accordance with the TIFF (Tagged Image File Format) which is an image format generally used by a computer. The specification of the TIFF is publicized by the U.S. Adobe System. As the name shows, the TIFF expresses data by using a tag to a data block within a file, and by using the tag, the TIFF is capable of storing, at the same time, a plurality of image data the resolution of which or the number of colors of which differs.

The modem 6 carries out modulation and demodulation of data to be transmitted and received data in accordance with the ITU-T Recommendation V.34 standard or something similar to this.

The NCU 7 is a network control device for calling or disconnecting the telephone by controlling a telephone line, and is connected to a PSTN (Public Switched Telephone Network) 13.

The scanning unit 8 scans image data of the original such as a document, and outputs the image data which is converted into binary data.

The printing unit 9 is, in one example, an electrophotographic type, and prints received image data onto recording paper. For example, by an instruction from the CPU 2, the printing unit 9 prints the image data of the original scanned by the scanning unit 8 or the image data received by facsimile.

The operation unit 10 includes a display 10a for displaying information concerning the condition of the I-FAX 1 and a screen for instructing various operations, a ten-key numeric pad 10b for inputting a FAX number or the like, a speed dial key 10c for carrying out calling by a speed dial number, a start key 10d for starting the scanning operation of the original, a cursor key 10e for moving a cursor within the display 10a. Various operations are carried out by the operation unit 10. Moreover, the operation unit 10 functions as an inputting unit for inputting a command and a keyword which instructs the processing of electronic mail, and as an electronic mail forming unit for forming electronic mail.

The LAN I/F 11 is provided with an interface which can be connected to a LAN (Local Area Network) 14, and connects the LAN 14 and the I-FAX 1 such that the communication can be carried out between them. In addition to that, since the I-FAX 1 is connected to the Internet via the LAN I/F 11, the LAN I/F 11 functions as a connecting unit to the Internet.

The I-FAX 1 can be connected to the ISDN (Integrated Services Digital Network) via the interface of the ISDN and via the DSU (Digital Service Unit). Moreover, the I-FAX 1 can be constructed so as to include a graphic/character generating unit and to convert character code data into image data. Furthermore, a clock unit can be provided for entering the date and time into the image data.

The I-FAX 1 having the above-mentioned hardware structure possesses a facsimile communication function following the general G3 method, an Internet facsimile function for transmitting and receiving image data of the original such as a document by electronic mail, and also possesses a function for handling a salutation protocol. By the salutation protocol, the I-FAX 1 can carry out the reciprocal communication with a client connected to the LAN 14. The salutation protocol is a communication protocol for specifying and managing a computer and an office machine by the Internet and the LAN, and the protocol is publicized by the Salutation Consortium.

Mail server software is installed in the I-FAX 1. For example, the I-FAX 1 is provided with the SMTP (Simple Mail Transfer Protocol) server function. Therefore, the I-FAX 1 is constructed such that so long as the domain name written after the boundary symbol is that of the I-FAX 1, electronic mail is distributed to the I-FAX 1, regardless of a format of the information which is written in front of a boundary symbol such as “@” of a mail address.

In addition, the I-FAX 1 carries out the processing of the received image data as well as the electronic mail, based on the mail account designated area of the mail address designated as the transmission destination, i.e., the specific information written in front of the boundary symbol “@” of the mail address of the received electronic mail. Specifically, as the specific information, the written information in front of the boundary symbol is a command showing the processing instruction of the image data received by the I-FAX 1, and is the operand which is the information showing the location, i.e., by carrying out the command, the image data is output at this location. If necessary, the information written in front of the boundary symbol further includes a password for carrying out confirmation of the transmitter. Basically, the I-FAX 1 carries out the processing indicated by these command and operand, to the received image data.

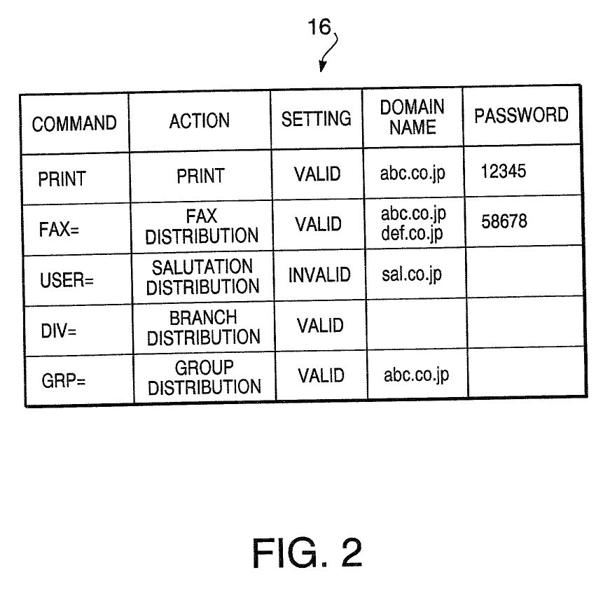

Furthermore, the I-FAX 1 carries out the processing indicated by the command and the operand, based on a data table which stores the processing attributes relating to the processing instruction of the command. That is, the I-FAX 1 holds the data table 16 shown in FIG. 2 within a predetermined storing area of the RAM 3. The processing indicated by the command and the operand is carried out based on the data table 16. The processing attributes stored in the data table 16 include the “action” section for designating what kind of processing is to be carried out, the “setting” section for designating whether the processing is valid or invalid, the “domain name” section for designating a domain name of the transmitter which gives processing permission, and the “password” section for designating a password which gives processing permission, regarding respective commands “PRINT”, “FAX=”, “USER=”, “DIV=” and “GRP=”. Moreover, the contents of the data table 16 can be edited freely from the operation unit 10 or the like.

In the received electronic mail, the I-FAX 1 obtains the mail address designated as the transmission destination and/or the mail address of the transmitter, from the received SMTP command.

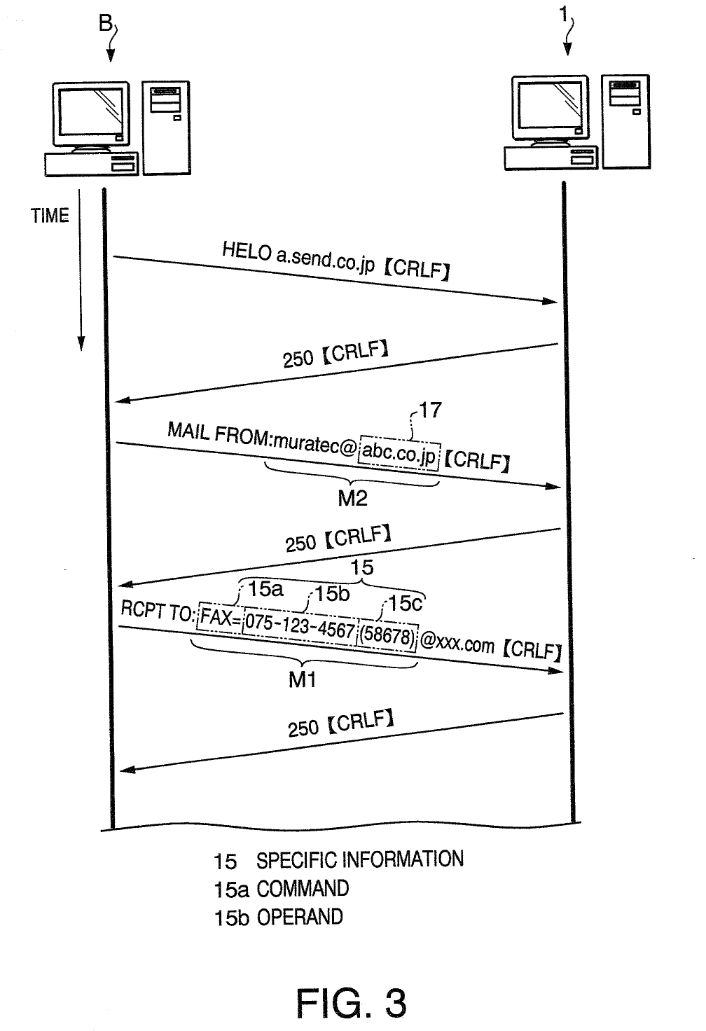

In other words, when the I-FAX 1 receives the electronic mail, as shown in FIG. 3, one TCP connection is established, and the control and the forwarding of the data is carried out over the connection.

At this time, the I-FAX 1 receives and obtains the information written in the back part of the SMTP command “RCPT TO:”, as a mail address M1 which has been designated as the transmission destination. This information is used for designating the receiver, and is received from the SMTP server B of the transmitting side.

For example, in the case where the SMTP command is “RCPT TO: FAX=075-123-4567(58678)@xxx.com”, the I-FAX 1 obtains “FAX=075-123-4567(58678) xxx.com” after “RCPT TO:”, as the mail address M1 designated as the transmission destination.

Moreover, the I-FAX 1 obtains the information written in the back part of the SMTP command “MAIL FROM:”, as a mail address M2 of the transmitter. This information is used for designating the transmitter, and is received from the SMTP server B of the transmitting side.

For example, in the case where the SMTP command is “MAIL FROM: muratec@abc.co.jp”, the I-FAX 1 obtains “muratec@abc.co.jp” after “MAIL FROM:”, as the mail address M2 of the transmitter.

Further, “HELO a.send.co.jp” shown in the drawings is the SMTP command for designating the start of the communication. “250” is a confirmation response to the SMTP server B of the transmitting side from the I-FAX 1. This response is used for designating the completion of the demanded processing of the mail, and “CRLF” shows a code for designating start of a new line.

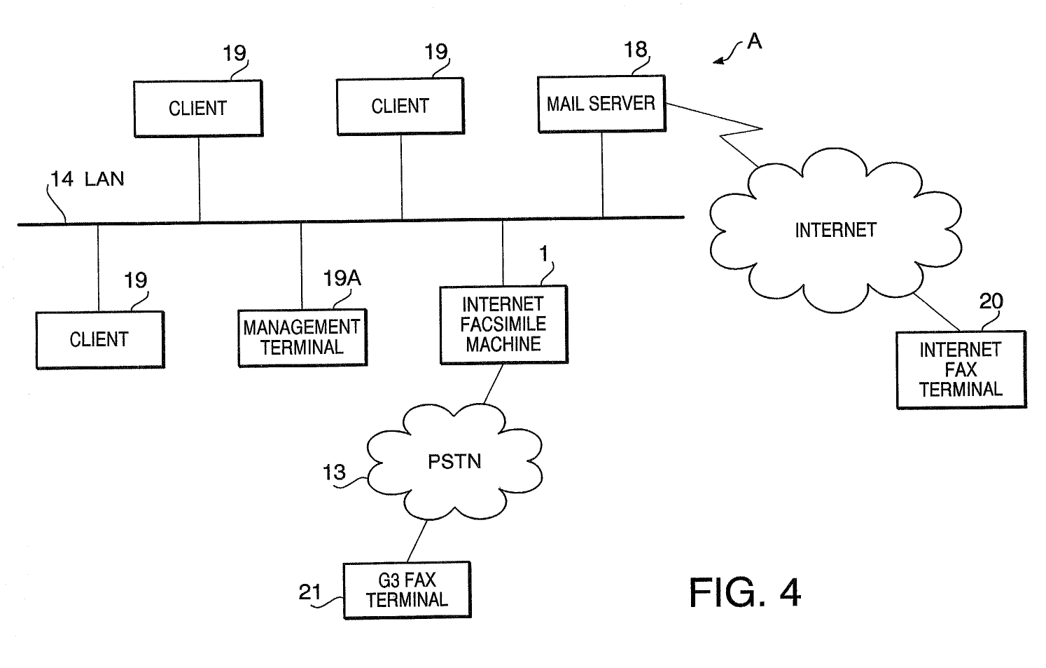

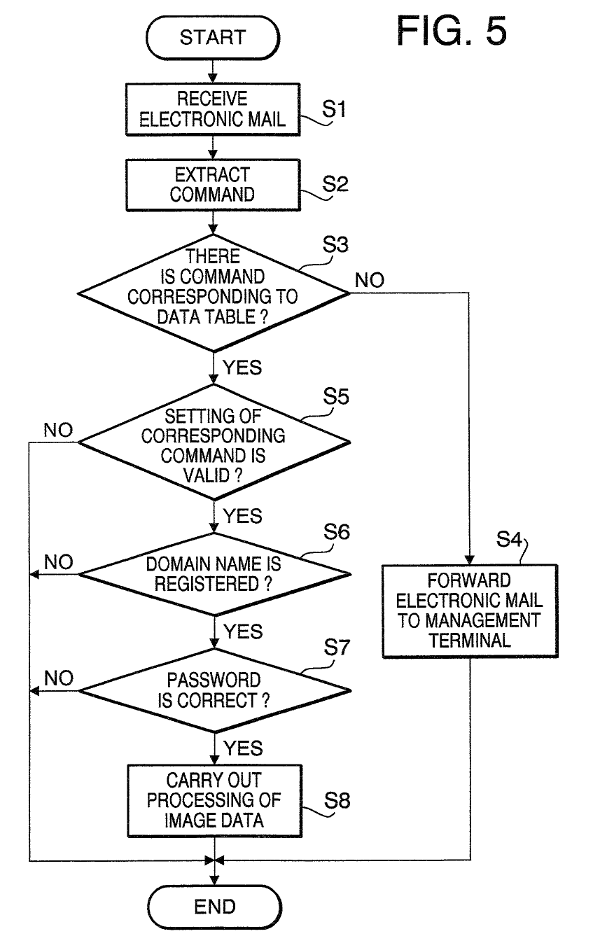

Based on the flow chart shown in FIG. 5, the operation when receiving the electronic mail will be described, in the case where the I-FAX 1 having the above-mentioned function and hardware structure is provided in the network environment (A) shown in FIG. 4. The operation is carried out by following a command generated, by the CPU 2, based on a control program stored in the ROM 4.

In the network environment (A) shown in FIG. 4, the I-FAX 1 is connected to, for example, a mail server 18, clients 19, a management terminal 19A which is a client and is used by a system manager, via the LAN 14, such that the communication can be carried out.

Therefore, the I-FAX 1 can transmit and receive the image data of the original or the like by electronic mail, to and from another Internet facsimile terminal 20, through the Internet. Moreover, the I-FAX 1 can transmit and receive the image data of the original by G3 facsimile, to and from another G3 FAX terminal 21, through the PSTN 13.

The clients 19 and the management terminal 19A are personal computers in which predetermined client software and electronic mail client software is installed, and are constructed so as to carry out the transmitting and receiving with the I-FAX 1, based on the salutation protocol, or /and by electronic mail.

First, when the I-FAX 1 receives electronic mail (in the step S1), as shown in FIG. 3, the mail address M1 which is designated as the transmission destination is obtained from the received SMTP command. In addition to that, the specific information 15 written in front of the boundary symbol “@” is extracted as a command 15a, an operand 15b, and a password 15c which indicate the processing instruction of the image data (in the step S2). The written part before “=” of the specific information 15 is determined as the command 15a, and the written part after “=” is determined as the operand 15b.

Next, referring to the data table 16 is carried out, and it is determined whether or not the extracted command 15a is within the “command” section of the data table 16 (in the step S3). That is, in the case where the extracted command 15a corresponds to one of “PRINT”, “FAX=”, “USER=”, “DIV=”, and “GRP=” which are shown in the “command” section of the data table 16, it is determined that the extracted command 15a is within the data table 16. In the case where the extracted command 15a does not correspond to any one of “PRINT”, “FAX=”, “USER=”, “DIV=”, and “GRP=” which are shown in the “command” section of the data table 16, it is determined that the extracted command 15a is not within the data table 16.

In the case where there is no command 15a corresponding to any one of the “command” section of the data table 16, or in the case where the command 15a is not written at all in the step S3, the electronic mail is forwarded to the management terminal 19A (in the step S4).

When it is determined that the extracted command 15a is present in the data table 16 in the step S3, the processing of the received image data is carried out based on the data table 16. Specifically, first, it is determined whether or not “setting” is valid, which is shown in the row of the command corresponding to the extracted command 15a in the data table 16 (in the step S5). When the “setting” is “valid”, the procedure proceeds to the next step, and on the other hand, when it is “invalid”, the operation is ended. For example, the extracted command 15a is present in the data table 16 of FIG. 2, and is “FAX=”, the “setting” is “valid”.

Next, in the case where the “setting” is “valid”, the processing is carried out for eliminating electronic mail transmitted from senders other than proper users. Specifically, it is determined whether or not one of domain names registered to respective commands in the data table 16 corresponds to the domain name 17 of the transmitter designated by the received SMTP command (in the step S6). In the case where one of the domain names corresponds to the domain name 17, it is determined whether or not the password registered relating to the command in the data table 16 corresponds to the password 15c written in a predetermined area within the received electronic mail, for example, within the parenthesis after the operand 15b (in the step S7). In the case where the password registered relating to the command in the data table 16 corresponds to the password 15c, the processing to the received image data such as printing, facsimile forwarding, or local distributing is carried out in accordance with “action” designated by the command (in the step S8).

Further, in the case where the “setting” is “invalid” in the step S5, in the case where there is not a domain name corresponding to the domain name 17 in the step S6, or in the case where the password written in the predetermined area within the received electronic mail does not correspond to the set “password” of the data table 16 in the step S7, the operation is ended.

Each item of the “action” to be carried out in the step S8 will be described. When the extracted command 15a is “PRINT”, the I-FAX 1 prints the received image data on recording paper by the printing unit 9 of the I-FAX 1.

In the case where the extracted command 15a is “FAX=”, and the operand 15b is, for example, “075-123-4567”, the received image data is distributed to the G3 FAX terminal 21 by G3 facsimile, with “075-123-4567” being a FAX number of the destination.

In the case where the extracted command 15a is “USER=”, and the operand 15b is “USERID”, the received image data is distributed to the client 19 or the like with “USERID” designated as an ID of the salutation client.

In the case where the extracted command 15a is “DIV=”, and the operand 15b is, for example, “111”, the received image data is distributed, by salutation, electronic mail, or the like, to the branch whose branch registered number is “111”. For example, the branch is the client 19.

In the case where the extracted command 15a is “GRP=”, and the operand 15b is, for example, “ABC”, the received image data is distributed, by salutation, G3 facsimile, or the like, to the group whose group registration number is “ABC”. For example, the group includes the client 19, the G3 FAX terminal 21, and/or the like.

Further, in this embodiment, as a data table for storing the processing attributes to the extracted command 15a, the data table 16 shown in FIG. 2 is used. However, “command”, “action”, “setting” sections, and the like are not limited to these kinds of sections shown in FIG. 2, and other kinds of sections may be set for the data table by changing the control program or the like.

With the above-mentioned I-FAX 1 of the embodiment of the present invention, at the transmitting side of the electronic mail, by writing predetermined command and operand within the mail account designated area of the mail address which is designated as a destination of the electronic mail, the processing of the image data to be transmitted can be designated for the I-FAX which will receive the image data.

Moreover, since the I-FAX 1 determines the processing of the received image data based on the command, the operand, and the data table, the I-FAX 1 can designate and perform various types of control to respective commands. Furthermore, since the contents of the data table 16 can be edited freely from the operation unit 10, the contents of the data table can be arranged flexibly so as to meet user's demand for the processing.

In addition, even in the case where there are mistakes or omission regarding the command, such electronic mail is forwarded to the manager. Therefore, even in the case where the processing desired by the transmitter is not carried out, the manager can notify such a result to the transmitter, and instruct the transmitter to carry out retransmission.

When transmitting electronic mail by the SMTP, the I-FAX 1 inputs the command of “RCPT TO” for designating the destination. Subsequently, the I-FAX 1 forms the message of the main text, attaches the image data to the electronic mail, and transmits the electronic mail to the communication terminal device of the destination.

According to the present invention, the indication of how the electronic mail should be processed can be input, as a keyword, in the parameter part of the command of “RCPT TO”. Accordingly, there is an advantage in that a communication terminal device such as an I-FAX at the receiving side can immediately carry out the processing of the electronic mail in accordance with the indication made by the I-FAX 1 at the transmitting side.

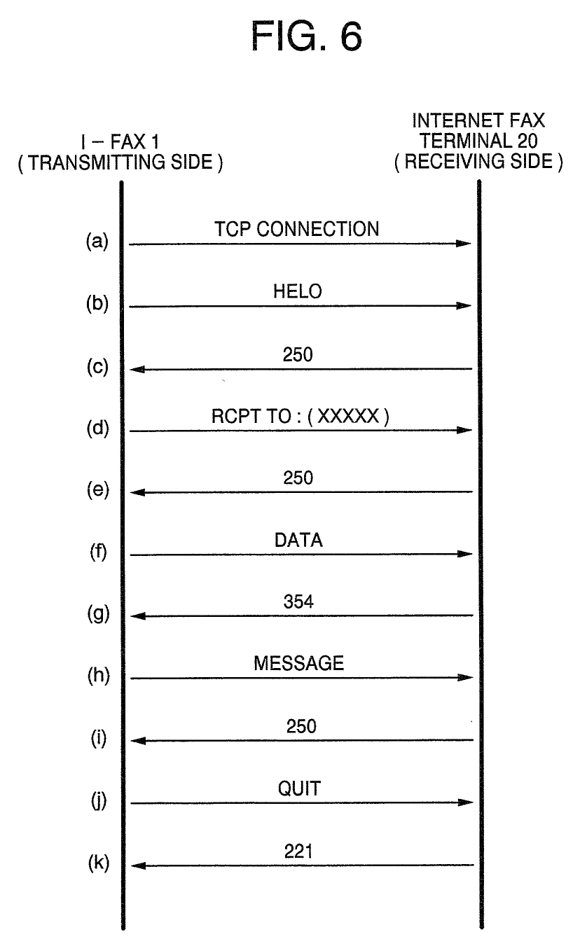

An example of an SMTP sequence according to another embodiment of the present invention is shown in FIG. 6. The electronic mail is transmitted from the I-FAX 1 of FIG. 4 to the Internet FAX terminal 20 of FIG. 4. In the process (a), the TCP (Transmission Control Protocol) connection is carried out between the I-FAX 1 and the Internet FAX terminal 20.

In the process (b), the I-FAX 1 of the transmitting side transmits, to the terminal 20 of the receiving side, the command “HELO” for starting the communication of the SMTP. In the procedure (c), the terminal 20 of the receiving side transmits the response “250” showing the completion of the demanded processing of the mail, in this example, the completion of the receiving of the “HELO” command.

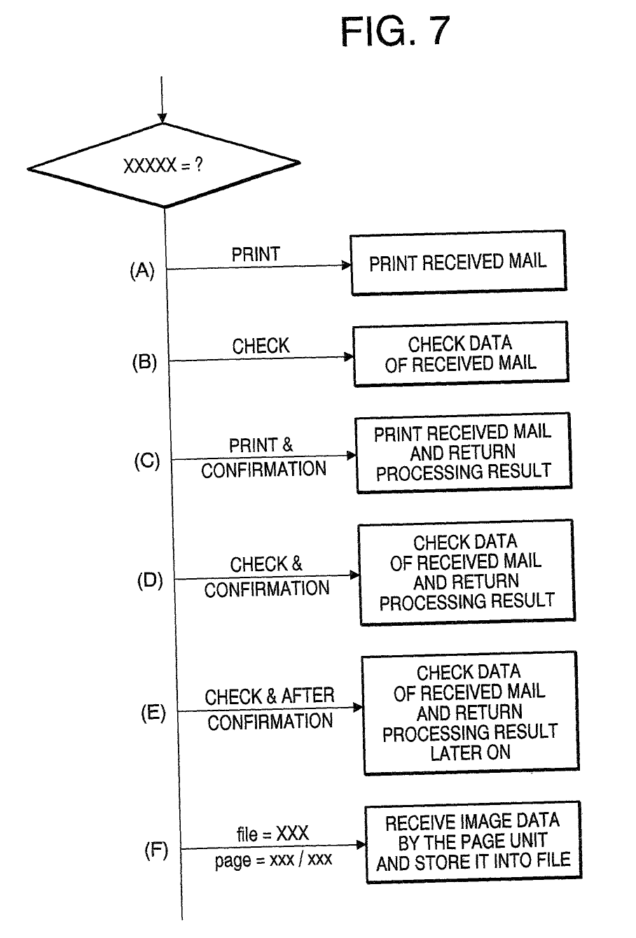

In the process (d), the keyword “XXXXX” for indicating the processing of the electronic mail is input at the parameter part of the SMTP designation command “RCPT TO” of the receiver, and then the I-FAX 1 at the transmitting side transmits the input keyword to the terminal 20 at the receiving side. The keyword “XXXXX” can be selected from the various processing patterns of electronic mail in accordance with the destination. The specific examples will be described with reference to FIG. 7.

In the process (e), the terminal 20 at the receiving side transmits the response “250” to the I-FAX 1 at the transmitting side. This response “250” indicates the completion of the receiving of the demanded command “XXXXX”. In the process (f), the I-FAX 1 at the transmitting side transmits, to the receiving side, the command “DATA” for the transmission of the main text of the electronic mail of the SMTP. In the process (g), the terminal 20 at the receiving side transmits, to the transmitting side, the response “354” for starting the data input of the electronic mail.

In the process (h), the I-FAX 1 at the transmitting side transmits the message of the main text of the electronic mail to the terminal 20 at the receiving side. In the process (i), the terminal 20 at the receiving side transmits, to the transmitting side, the response “250” to the effect that the receiving of the message is completed. In the process (j), the I-FAX 1 at the transmitting side transmits the SMTP ending command “QUIT” to the receiving side. In the process (k), the terminal 20 at the receiving side transmits, to the transmitting side, the response “221” showing the end of the service.

Next, processing patterns will be described with reference to the flow chart of FIG. 7. In the case (A), the keyword “XXXXX” is “PRINT”, and the terminal at the receiving side carries out the print processing of the received electronic mail. In the case (B), the keyword “XXXXX” is “CHECK”, and the terminal at the receiving side checks the data of the received electronic mail. In the case (C), the keyword “XXXXX” is “PRINT&CONFIRMATION”, and the terminal at the receiving side prints the data of the received electronic mail such as image data, and sends a reply showing the processing result to the transmitting side, within the same SMTP session. For example, the processing result may be the result of the printing.

In the case (D), the keyword “XXXXX” is “CHECK&CONFIRMATION”, and the terminal at the receiving side checks the data of the received electronic mail, and sends a reply showing the processing result to the transmitting side, within same SMTP session. For example, the processing result may be the result of the data checking. In the case (E), the keyword “XXXXX” is “CHECK&AFTER CONFIRMATION”, and the terminal at the receiving side checks the data of the received electronic mail, and sends a reply showing the processing result to the transmitting side later on. For example, the processing result may be the result of the data checking.

In the case (F), the keyword “XXXXX” is “file=XXX, page=XXX/XXX”, and the terminal at the receiving side receives the electronic mail by the page unit, and stores the received electronic mail into the file. For example, in the case where “file=001” is designated by the keyword, the terminal at the receiving side recognizes that the electronic mail is of a series of pages of the file “file=001”.

Moreover, by adding the page number to the file number, the processing of the receiving side can be carried out more efficiently. For example, when the file number “001” has five pages, i.e., five electronic mails, the keyword for transmitting the first page is “file=001, page=001/005”.

By carrying out the processing of the case (F), in the case of transmitting the original of a plurality of pages by electronic mail, the electronic mail is formed for every page (when there are five pages, e-mail is formed five times), and a plurality of electronic mails are transmitted within one SMTP session. Therefore, there is an advantage in that the terminal at the receiving side can process the received electronic mail by the page unit.

As shown in FIG. 7, various patterns are set for the processing of the electronic mail. Therefore, each time the facsimile communication is carried out, the necessary processing is indicated in a manner in which the necessary processing is selected from various patterns of the processing of the electronic mail in accordance with a destination.

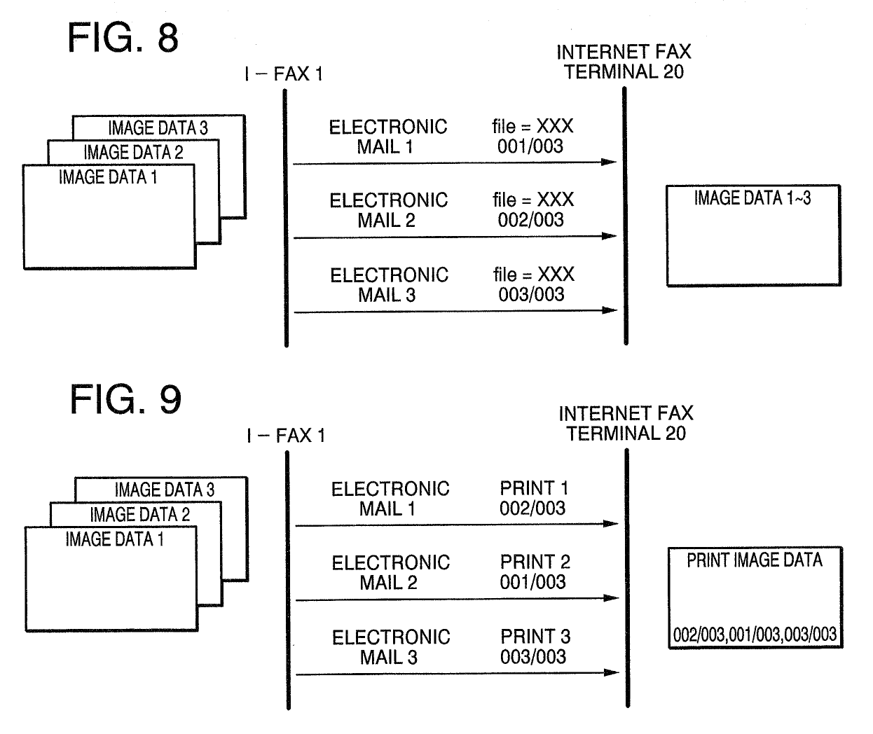

FIGS. 8 and 9 illustrate specific examples of the processing case (F) of FIG. 7. In FIG. 8, the I-FAX 1 at the transmitting side divides the image data comprised of the consecutive pages into respective page units, attaches each of the image data 1 through the image data 3 of respective pages to each electronic mail respectively, and transmits each electronic mail to the Internet FAX terminal 20 at the receiving side.

As in the manner stated above, since the image data comprised of consecutive pages is divided into respective page units, attached to each electronic mail respectively, and transmitted to the terminal at the receiving side. Accordingly, the risk when transmitting the image data in the form of the electronic mail can be divided. For example, assuming that a virus infects a certain electronic mail and the image data is destroyed, even in the case where such situation occurs, if other electronic mails can be received normally, the safety can be maintained for the image data attached to the other electronic mails which are not infected with a virus.

At this time, as described in the case (F) of FIG. 7 for the processing of each electronic mail, the I-FAX 1 at the transmitting side inputs the file name “file=XXX” of the image data comprised of the consecutive pages into the designation command of each electronic mail as a keyword. Furthermore, the I-FAX 1 at the transmitting side inputs the information of how many pages the image data of the file name has, i.e., the information of the total number of pages of the image data, and the information of what page number the image data attached to each of electronic mails 1 through 3 corresponds to, i.e., the information concerning the page number of the image data attached to each of the electronic mails 1 through 3, and the I-FAX 1 at the transmitting side transmits, to the receiving side, the input information along with the file name.

In this example, the electronic mail 1 is electronic mail to which the first-page image data of the image data comprised of three pages is attached. The electronic mail 2 is electronic mail to which the second-page image data comprised of three pages is attached. The electronic mail 3 is electronic mail to which the third-page image data of the image data comprised of three pages is attached.

When the Internet FAX terminal 20 at the receiving side receives each of electronic mails 1 through 3 transmitted from the I-FAX 1, the Internet FAX terminal 20 at the receiving side 20 interprets the keyword input in each electronic mail, and carries out an appropriate processing. In this example, the image data 1 through the image data 3 is collected as one image data.

In the example shown in FIG. 9, in the same manner as described in FIG. 8, the I-FAX 1 at the transmitting side divides the image data comprised of consecutive pages into page units, and attaches the image data 1 through the image data 3 of respective pages to each electronic mail respectively, and transmits each electronic mail to the Internet FAX terminal 20 at the receiving side.

At this time, the I-FAX 1 at the transmitting side transmits the keyword of the designation command of each electronic mail to the Internet FAX terminal 20 at the receiving side. The keyword is the processing order of the image data. In other words, the processing of the image data attached to each electronic mail should be carried out in this order. For example, the designation of the processing order may be the printing order, or the forwarding order of electronic mail.

In FIG. 9, the I-FAX 1 at the transmitting side inputs the keyword which indicates the printing order such that the second-page image of the image data comprised of three pages should be first printed, and transmits, to the Internet FAX terminal 20 at the receiving side, the electronic mail 1 having this input keyword, with the second-page image data attached thereto. Furthermore, the I-FAX 1 transmits the electronic mail 2 having the indication that the first-page image data of the image data comprised of three pages should be second printed, with the first-page image data attached thereto. In addition, the I-FAX 1 transmits the electronic mail 3 having the indication that the third-page image data of the image data comprised of three pages should be third printed, with the third-page image data attached thereto.

The Internet FAX terminal 20 at the receiving side interprets the keyword input in each received electronic mail, and carries out the processing in the order indicated by the I-FAX 1 at the transmitting side. In this example, the image data is printed in this order. In other words, the second page is first printed, the first page is second printed, and the third page is third printed.

In the example shown in FIG. 9, the processing order of the image data of the same file is input as a keyword. However, according to the present invention, when transmitting the image data of different files to the receiving side by attaching the image data to the each electronic mail respectively, the processing order such as printing order can be input as a keyword, concerning each file.

While the embodiment of the present invention, as herein disclosed, constitutes a preferred form, it is to be understood that other forms might be adopted.

What is claimed is:

1. An Internet facsimile machine comprising:
means for receiving electronic mail; and
means for carrying out processing of the received electronic mail and image data attached to the electronic mail, based on specific information written in a mail account designated area of a mail address designated as a transmission destination in the received electronic mail.

2. The Internet facsimile machine according to claim 1, wherein the specific information includes a command which shows a processing instruction of the image data.

3. The Internet facsimile machine according to claim 2, wherein the electronic mail includes a domain name such that so long as the domain name is a domain name of the Internet facsimile machine, the electronic mail is distributed to the Internet facsimile machine.

4. The Internet facsimile machine according to claim 2, wherein the specific information further includes a password, and the Internet facsimile machine carries out confirmation of a transmitter which has transmitted the electronic mail, by using the password.

5. The Internet facsimile machine according to claim 2, wherein the processing instruction includes one of: printing instruction of the image data; facsimile forwarding instruction of the image data; and local distributing instruction of the image data.

6. The Internet facsimile machine according to claim 2, wherein when the processing instruction includes facsimile forwarding instruction of the image data or local distributing instruction of the image data, the specific information further includes an operand which is information showing a location, and the Internet facsimile machine carries out the facsimile forwarding of the image data to the location or the local distributing of the image data to the location.

7. The Internet facsimile machine according to claim 2, further including means for storing processing instructions and processing attributes relating to the processing instruction, wherein the Internet facsimile machine carries out processing of the image data based on the processing attributes.

8. The Internet facsimile machine according to claim 7, further including means for determining whether or not there is the processing instruction in the means for storing, wherein if there is not the processing instruction in the means for storing, the Internet facsimile machine forwards the electronic mail to a management terminal.

9. The Internet facsimile machine according to claim 1, wherein the means for receiving receives the electronic mail by SMTP (Simple Mail Transfer Protocol).

10. An Internet facsimile machine comprising:
an inputting unit for inputting a keyword which designates a processing pattern of electronic mail;
an electronic mail forming unit for forming the electronic mail, the electronic mail including the keyword in a mail account designated area of a mail address; and
a connection part for carrying out connection to the Internet, wherein the Internet facsimile machine carries out transmission of the electronic mail having the keyword to a receiving side via the Internet such that the receiving side can carry out processing of the electronic mail based on the keyword.

11. The Internet facsimile machine according to claim 10, wherein the Internet facsimile machine divides image data comprised of consecutive pages into page units, and attaches each of the divided image data to each electronic mail, and transmits the each electronic mail having the keyword and the each divided image data.

12. The Internet facsimile machine according to claim 11, wherein the keyword includes a file name of the image data comprised of the consecutive pages, a total page number of the image data having the file name, a page number of the image data attached to the each electronic mail.

13. The Internet facsimile machine according to claim 11, wherein the keyword includes information of processing order of the image data attached to the each electronic mail.

14. The Internet facsimile machine according to claim 10, wherein the processing pattern includes one of: printing of data of the electronic mail; data checking of the electronic mail; printing of data of the electronic mail and a reply to the Internet facsimile machine concerning a result of the printing; and data checking of the electronic mail and a reply to the Internet facsimile machine concerning a result of the data checking.

15. The Internet facsimile machine according to claim 13, wherein the processing order is printing order, and when the Internet facsimile machine transmits the each electronic mail having the keyword and the each divided image data, the processing pattern includes receiving of the image data by the page unit and printing of the image data attached to the each electronic mail in accordance with the printing order.

16. The Internet facsimile machine according to claim 10, further including:
means for receiving electronic mail; and
a control unit for determining processing of the received electronic mail based on a keyword attached to the received electronic mail.

17. An Internet facsimile machine comprising:
means for receiving electronic mail; and
means for carrying out processing of the received electronic mail, based on specific information written in a mail account designated area of a mail address designated as a transmission destination in the received electronic mail.

18. An Internet facsimile communication method for carrying out facsimile communication by an electronic mail protocol, said method comprising:
attaching a keyword which instructs a processing pattern of electronic mail to a destination designation command of the electronic mail protocol; and
transmitting the electronic mail having the attached keyword to a communication terminal at a destination via the Internet.

19. The method according to claim 18, further including:
dividing image data comprised of consecutive pages into page units;
attaching each divided image data to each electronic mail;
transmitting the each electronic mail having the keyword which includes a file name of the image data comprised of the consecutive pages, information of a total page number of the image data having the file name, and information of a page number of the each image data attached to the each electronic mail.

20. The method according to claim 18, further including:
dividing image data comprised of consecutive pages into page units;
attaching each divided image data to each electronic mail;
transmitting the each electronic mail having the keyword which includes information of processing order of the each image data which is attached to the each electronic mail.

21. The method according to claim 18, wherein the processing pattern includes one of: printing of data of the electronic mail; data checking of the electronic mail; printing of data of the electronic mail and a reply concerning a result of the printing; and data checking of the electronic mail and a reply concerning a result of the data checking

22. The method according to claim 20, wherein the processing pattern is receiving of the each image data by the page unit and printing of the each image data in accordance with the processing order.
